(19) United States
(12) Patent Application Publication
(10) Pub. No.: US 2007/0030113 A1
(43) Pub. Date: Feb. 8, 2007

(54) Chip type electric device and liquid crystal display module including the same

(75) Inventors: Ki Hong Song, Suwon-si (KR); Joong Soo Moon, Cheonan-si (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 11/433,274

(22) Filed: May 12, 2006

(30) Foreign Application Priority Data
Aug. 3, 2005 (KR) 10-2005-71006

(51) Int. Cl. G09G 3/19

(52) U.S. Cl. 338/309; 345/49; 345/99; 338/332

(57) ABSTRACT

A chip type electric device includes a body, a pair of electrodes coupled to the body, for electrically connecting the body to a pad of a printed circuit board, and an insulating layer for covering the upper surfaces of the electrodes and the body.

### CROSS-REFERENCE TO RELATED APPLICATION

This application claims priority to Korean Patent Application No. 10-2005-0071006, filed on Aug. 3, 2005, in the Korean Intellectual Property Office, the disclosure of which is herein incorporated by reference in its entirety.

### BACKGROUND OF THE INVENTION

1. Technical Field

The present invention relates to a semiconductor device, and more particularly, to a chip type electric device and a liquid crystal display (LCD) module including the same.

2. Description of Related Art

As demands for small-sized, lightweight electronic products have grown, chip type electric devices have been widely used to increase the wiring density of a circuit board. The chip type electric devices may be, for example, a multilayer ceramic capacitor (MLCC), a chip resistor, a chip ferrite bead, etc.

The multilayer ceramic capacitor is a chip type capacitor comprising a dielectric layer and internal electrodes layered with a small thin film. The chip resistor is a resistor implemented as a surface package. The chip bead is a surface package type inductor used to remove noise of an electronic product.

FIG. 1 is a schematic cross-sectional view of a chip type electric device 14. The chip type electric device 14 is connected to pads 12 of a printed circuit board 10 through shoulders 20. Electrodes 18 are formed of a conductive material and coupled to both ends of a body 16, since upper surfaces of the electrodes 18 are exposed, a short may occur between the electrodes 18 and an external conductive structure 22 positioned at the top of the electric device 14. For example, if the chip type electric device is packaged on a printed circuit board connected to an LCD panel, a short may occur by a direct contact between a top or bottom chassis surrounding the LCD panel and the chip type electric device or by an indirect contact through other metal materials such as a lead ball.

Therefore, a need exists for a chip type electric device capable of substantially preventing a short between electrodes connecting the device to a circuit board.

### SUMMARY OF THE INVENTION

In accordance with an exemplary embodiment of the present invention, a chip type electric device includes a body, a pair of electrodes coupled to the body, for electrically connecting the body to a pad of a printed circuit board, and an insulating layer for covering a surface of the electrodes and the body.

One or more pair of electrodes can be coupled to the body. The body and the insulating layer can be formed as a unit.

In accordance with an exemplary embodiment of the present invention, an LCD module includes an LCD panel, a printed circuit board connected to the LCD panel through a film, a conductive structure for surrounding a part of the LCD panel, and a chip type electric device packaged in the printed circuit board, wherein the chip type electric device includes a body, a pair of electrodes coupled to the body, for electrically connecting the body to a pad of a printed circuit board, and an insulating layer for covering a surfaces of the electrodes and the body.

### BRIEF DESCRIPTION OF THE DRAWINGS

Embodiments of the present invention will become more apparent from the following detailed description when taken in conjunction with the accompanying drawings in which:

FIG. 1 is a cross-sectional view of a conventional chip type electric device packaged in a printed circuit board;

FIG. 2 is a perspective view of a ceramic capacitor, which is a chip type electric device according to an embodiment of the present invention;

FIG. 3 is a perspective view of a ceramic capacitor array, which is a chip type electric device according to an embodiment of the present invention;

FIG. 4 is a cross-sectional view of a chip resistor, which is a chip type electric device according to an embodiment of the present invention;

FIG. 5 is a cross-sectional view of the chip resistor of FIG. 3 packaged in a printed circuit board;

FIG. 6 is a cross-sectional view of a chip ferrite bead, which is a chip type electric device according to an embodiment of the present invention;

FIG. 7 is a cross-sectional view of the chip ferrite bead of FIG. 6 packaged in a printed circuit board;

FIG. 8 is a detailed perspective view of a body of the chip ferrite bead shown in FIGS. 6 and 7;

FIG. 9 is a schematic exploded perspective view of an LCD module having the ceramic capacitor shown in FIG. 2;

FIG. 10 is a cross-sectional view taken along a line I-I′ of the LCD module shown in FIG. 9;

FIG. 11 is a perspective view of another LCD module having the ceramic capacitor shown in FIG. 2;

FIG. 12 is a cross-sectional view taken along a line II-II′ of the LCD module shown in FIG. 11;

FIG. 13 is a schematic exploded perspective view of a further LCD module having the ceramic capacitor shown in FIG. 2; and

FIG. 14 is a cross-sectional view taken along a line III-III′ of the LCD module shown in FIG. 13.

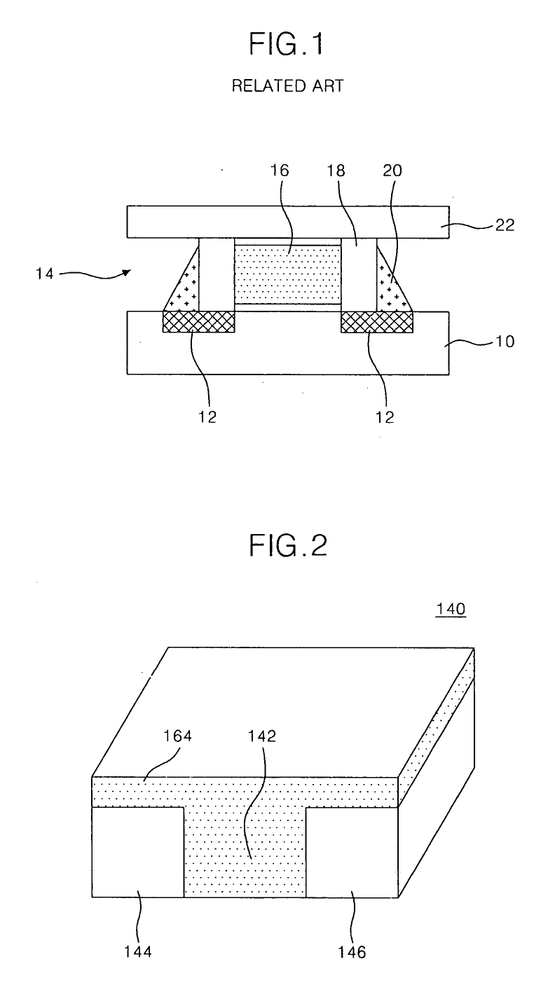

### DETAILED DESCRIPTION OF PREFERRED EMBODIMENTS

Preferred embodiments of the present invention will be described herein below with reference to the attached drawings.

Referring to FIG. 2, a chip type electric device according to an embodiment of the present invention may be a multilayer ceramic capacitor 140. The multilayer ceramic capacitor 140 includes first and second electrodes 144 and 146 which are spaced at a given interval, a body 142 formed between the first and second electrodes 144 and 146, and an insulating layer 164 for covering the first and second electrodes 144 and 146 and the body 142.

The first and second electrodes 144 and 146 are formed of a conductive material such as silver (Ag), copper (Cu), nickel (Ni), aluminum (Al), etc. The capacitance of the capacitor is substantially proportional to surface areas of the first and second electrodes 144 and 146.

The body 142 is a dielectric layer in which a ceramic dielectric material and an internal electrode are repeatedly deposited. The permittivity and thickness of the ceramic dielectric material determine the capacitance of the capacitor.

The insulating layer 164 is formed of an insulating material, preferably, a ceramic material constituting the body 142.

The insulating layer 164 may be formed with the body 142 as a single unit as shown in FIG. 2.

The insulating layer 164 covers the upper surfaces of the first and second electrodes 144 and 146, substantially preventing a short with an external conductive structure.

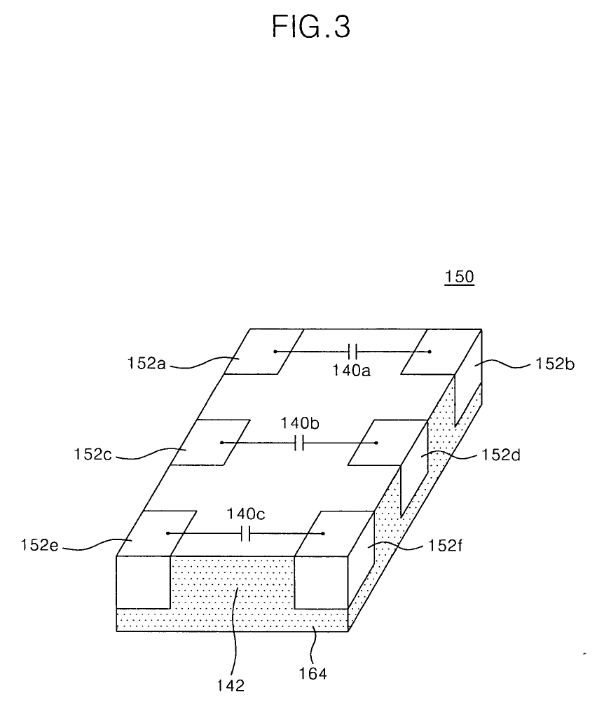

FIG. 3 is a perspective view of a multilayer ceramic capacitor array 150, which is a chip type electric device according to an embodiment of the present invention.

The multilayer ceramic capacitor array 150 has a structure in which three ceramic capacitors 140a, 140b, and 140c are formed in parallel with each other. The number of the ceramic capacitors contained in the ceramic capacitor array 150 is not restricted to 3.

The first capacitor 140a includes first and second electrodes 152a and 152b which are spaced at a given interval, the body 142 formed between the first and second electrodes 152a and 152b, and the insulating layer 164 for covering the first and second electrodes 152a and 152b and the body 164.

The second capacitor 140b includes third and fourth electrodes 152c and 152d which are spaced at a given interval, the body 142 formed between the third and fourth electrodes 152c and 152d, and the insulating layer 164 for covering the third and fourth electrodes 152c and 152d and the body 164.

The third capacitor 140c includes fifth and sixth electrodes 152e and 152f which are spaced at a given interval, the body 142 formed between the fifth and sixth electrodes 152e and 152f, and the insulating layer 164 for covering the fifth and sixth electrodes 152e and 152f and the body 164.

The construction and function of the first to sixth electrodes 152a, 152b, 152c, 152d, 152e and 152f, the body 142 and the insulating layer 164 are the same as those described with respect to FIG. 2 and therefore a detailed description thereof will be omitted.

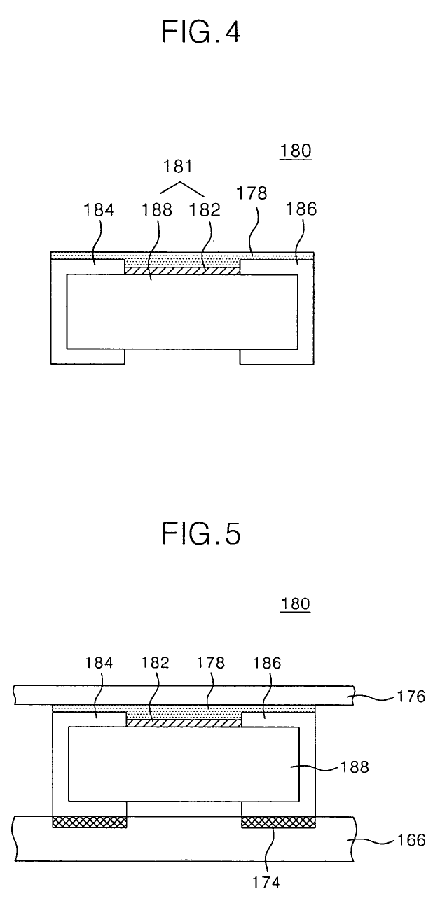

FIG. 4 is a cross-sectional view of a chip resistor 180, which is a chip type electric device according to an embodiment of the present invention, and FIG. 5 is a cross-sectional view of the chip resistor 180 of FIG. 3 packaged in a printed circuit board 166.

The chip resistor 180 includes a body 181, first and second electrodes 184 and 186 formed at both ends of the body 181, and an insulating layer 178 for covering the body 181 and the first and second electrodes 184 and 186.

The body 181 includes a ceramic substrate 188 made of an insulating material, and a resistor element 182 made of a resistance material such as ruthenium oxide (RuO₂). The resistor element 182 is electrically connected to the first and second electrodes 184 and 186 on the ceramic substrate 188.

The first and second electrodes 184 and 186 are formed of metal such as Ag, Cu, Ni, Al, etc., and connected to a pad 174 formed on the printed circuit board 166 as shown in FIG. 5.

The insulating layer 178 is formed of an insulating material, glass for example, and coated on the upper surfaces of the resistor element 182 and the first and second electrodes 184 and 186. As shown in FIG. 5, a short is substantially prevented between the first and second electrodes 184 and 186 and an external conductive structure 176 positioned on the upper surface of the chip resistor 180.

It will be apparent that embodiments of the present invention are applicable to a chip resistor array in which a plurality of chip resistors 180 are formed as a unit.

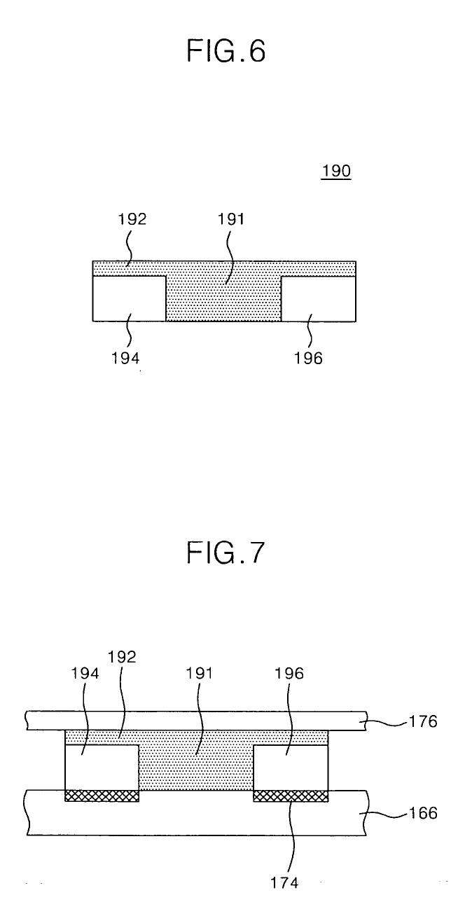

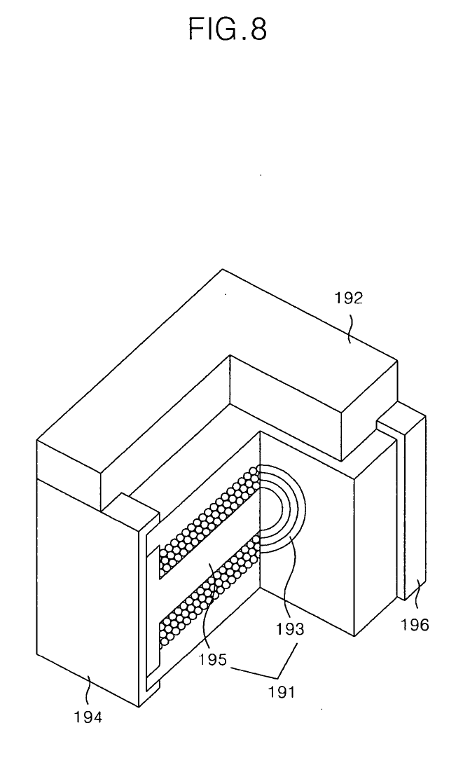

FIG. 6 is a cross-sectional view of a chip ferrite bead 190 which is a chip type electric device according to an embodiment of the present invention, FIG. 7 is a cross-sectional view of the chip ferrite bead 190 packaged in the printed circuit board 166, and FIG. 8 is a perspective view of a body 191 of the chip ferrite bead 190 shown in FIGS. 6 and 7.

The chip ferrite bead 190 includes the body 191, first and second electrodes 194 and 196 formed at both ends of the body 191, and an insulating layer 192 for covering the body 191 and the first and second electrodes 194 and 196.

As shown in FIG. 8, the body 191 includes a ferrite layer 193 and conductive wiring 195 passing through the ferrite layer 193. The ferrite layer 193 substantially removes noise of a signal transmitted through the conductive wiring 195.

The first and second electrodes 194 and 196 are formed of metal such as Ag, Cu, Ni, Al, etc., and are connected to pads 174 formed on the printed circuit board 166 as shown in FIG. 7.

The insulating layer 192 is made of an insulating material and covers the body 191 and the first and second electrodes 194 and 196. A short between the first and second electrodes 194 and 196 and the external conductive structure 176 positioned on the upper surface of the chip ferrite bead 190 is substantially prevented.

It will be apparent that embodiments of the present invention are applicable to a chip ferrite bead array in which a plurality of chip ferrite beads 190 are formed as a unit.

Moreover, embodiments of the present invention can be applied to all the chip type electric devices having a structure in which an external electrode, of which upper surface is exposed, is connected to a body.

Hereinafter, embodiments of an LCD module will be described.

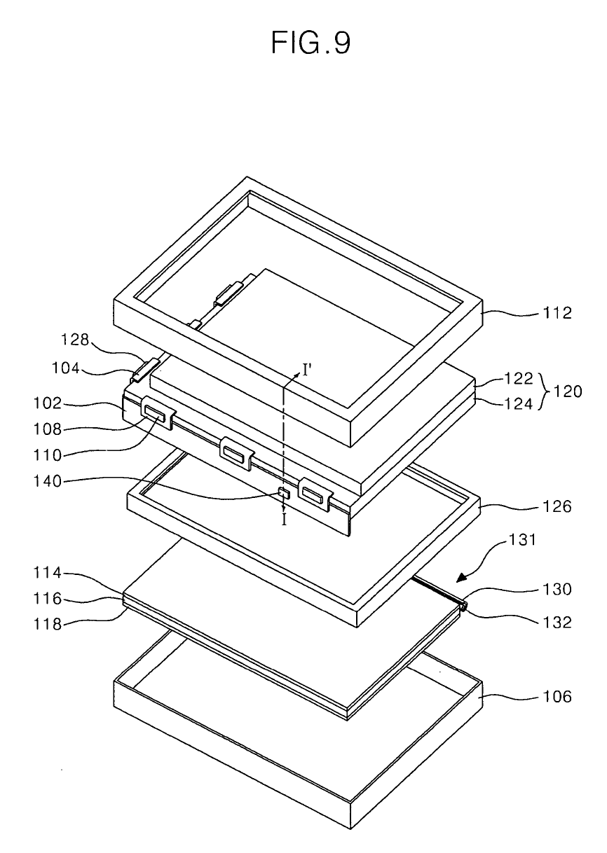

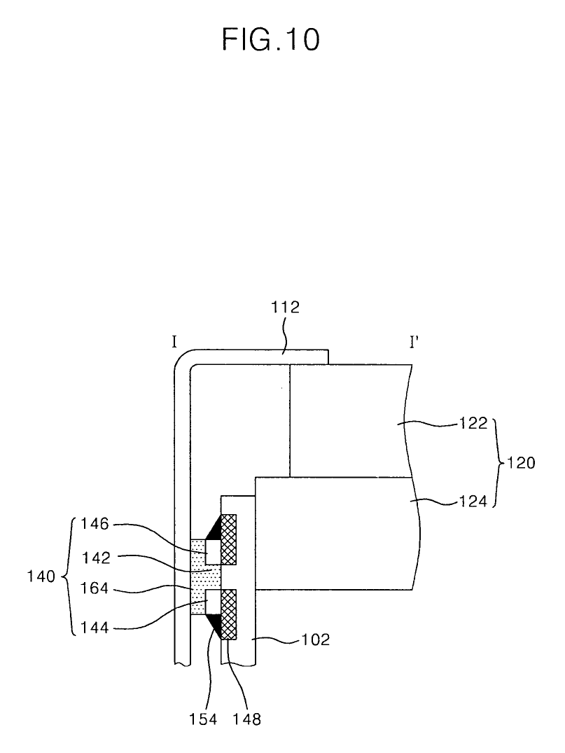

FIG. 9 is a schematic exploded perspective view showing an embodiment of an LCD module to which the ceramic capacitor 140 shown in FIG. 2 is applied. FIG. 10 is a cross-sectional view taken along a line I-I′ of the LCD module shown in FIG. 9.

The LCD module includes an LCD panel 120, a backlight unit 131 for supplying light to the LCD panel 120, a frame 126 for surrounding the sides of the LCD panel 120, and top and bottom chassis 112 and 106 for encompassing the backlight unit 131, the LCD panel 120 and the frame 126.

The backlight unit 131 includes a lamp 132 for generating light, a lamp housing 130 for supporting the lamp 132 and reflecting light generated from the lamp 132 to a light guide plate 116. The light guide plate 116 converts line light transmitted from the lamp 132 into surface light. A reflective sheet 118 installed at the rear of the light guide plate 116 reflects light to the top, and a plurality of optical sheets 114 deposited sequentially on the light guide plate 116 improve light uniformity and light efficiency.

The LCD panel 120 includes a thin film transistor 124 and a color filter substrate 122 which face each other and are assembled with a liquid crystal interposed there between.

Gate tape carrier packages (TCPs) 104 and data TCPs 108 are attached to the LCD panel 120. The gate TCPs include a gate integrated circuit 128 for driving gate lines. The data TCPs 108 include a data integrated circuit 110 for driving data lines. The gate TCPs and data TCPs are respectively connected to a gate printed circuit board (not shown) and a data printed circuit board 102. A variety of chip type electric devices such as the multilayer ceramic capacitor 140, a chip resistor, a chip bead, etc. can be attached to the printed circuit board 102 by a shoulder 154 as shown in FIG. 10.

Since the upper surfaces of the electrodes 144 and 146 of the multilayer ceramic capacitor 140 attached to the printed circuit board 102 are covered with the insulating layer 164, a short between the electrodes 144 and 146 and the top chassis 112 of a metal material is substantially prevented.

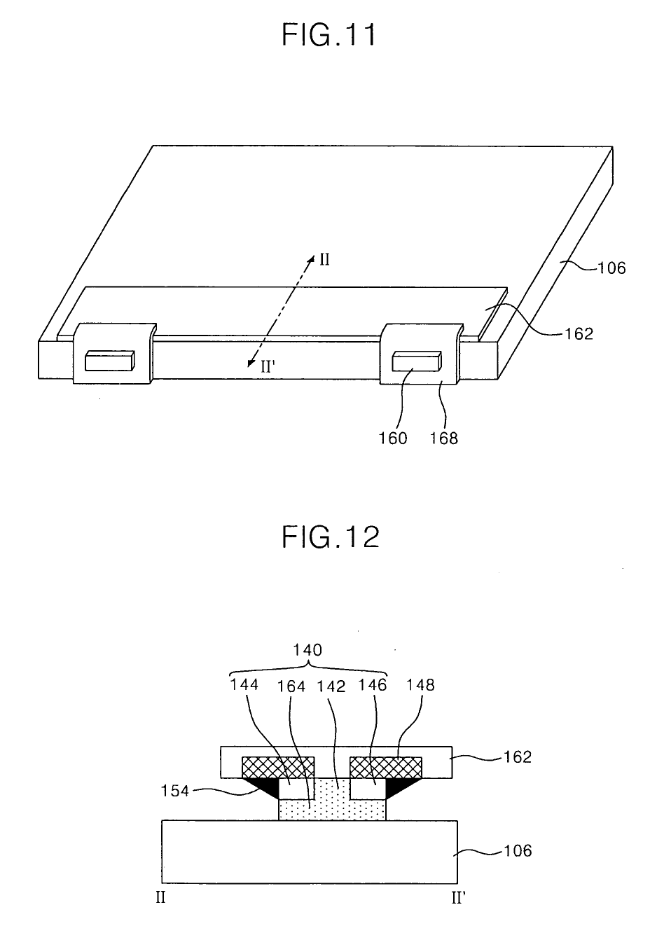

FIG. 11 is a perspective view of an LCD module to which the ceramic capacitor 140 shown in FIG. 2 is applied, and FIG. 12 is a cross-sectional view taken along a line II-II′ of the LCD module shown in FIG. 11.

The LCD module shown in FIG. 11 has a structure in which a printed circuit board 162 is connected to a panel through a flexible TCP 168 and an upper surface of the printed circuit board 162 is attached to the back of the bottom chassis 106.

Passive elements such as a resistor, the multilayer ceramic capacitor 140 and an inductor, a timing controller, a power source, etc. can be attached to the upper surface of the printed circuit board 162 by the shoulder 154.

Although an upper surface of the multilayer ceramic capacitor 140 may be in contact with a back of the bottom chassis 106, since the upper surfaces of the electrodes 144 and 146 are covered with the insulating layer 164, a short between the bottom chassis 106 and the electrodes 144 and 146 is substantially prevented.

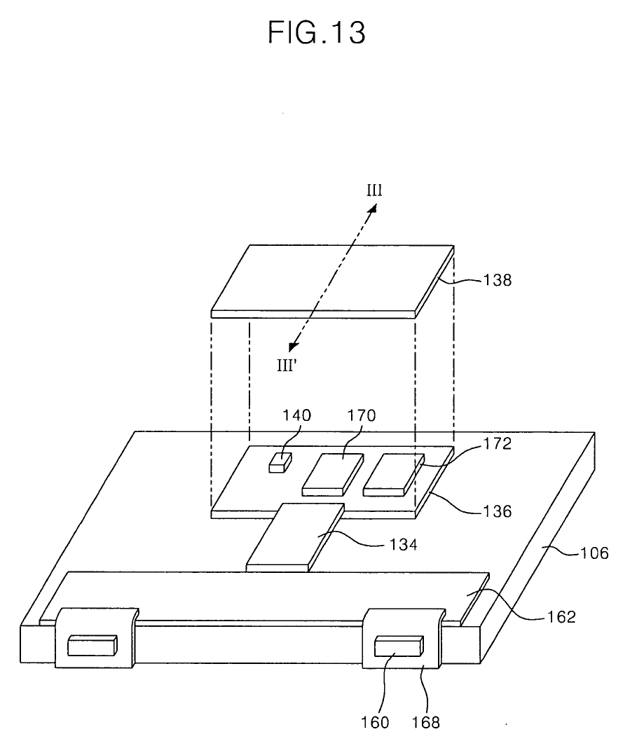

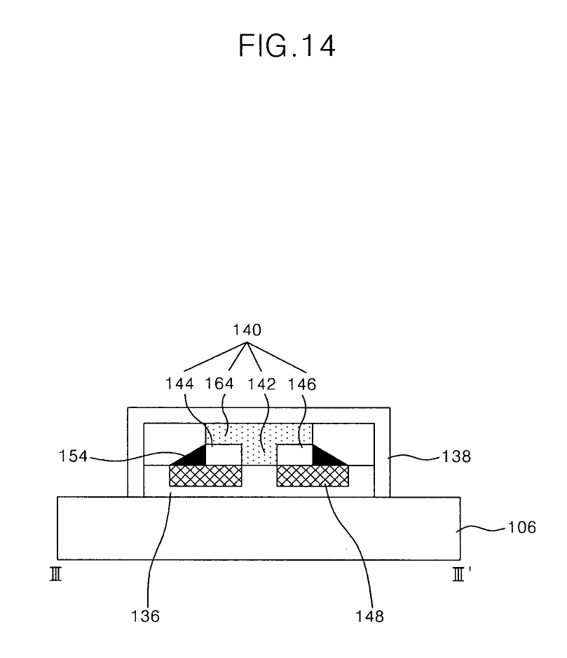

FIG. 13 is a schematic exploded perspective view of an LCD module to which the ceramic capacitor shown in FIG. 2 is applied, and FIG. 14 is a cross-sectional view taken along a line III-III′ of the LCD module shown in FIG. 13.

In the LCD module shown in FIG. 13, a first printed circuit board 162 is connected to a second printed circuit board 136 through a flexible printed circuit board 134. The first printed circuit board 162 includes an analog circuit for driving the LCD panel and a signal transmission bus for transmitting a display signal. The second printed circuit board 136 includes a signal processing circuit including the multilayer ceramic capacitor 140, a timing controller 170 and a power source 172.

The second printed circuit board 136 is protected by a shield case 138 for shielding electromagnetic waves. The shield case 138 is in contact with the electrodes of a chip type electric device, the multiplayer ceramic capacitor 140, the timing controller 170 and the power source 172 packaged in the second printed circuit board 136. A short is substantially prevented because the upper surfaces of the electrodes 144 and 146 of the multilayer ceramic capacitor 140 are covered with the insulating layer 164.

A chip type electric device and an LCD module including the same in accordance with an embodiment of the present invention can substantially prevent a short between electrodes of a chip type electric device and an external conductive structure, decreasing malfunction and defects of a product.

While embodiments of the present invention have been described, it will be understood by those skilled in the art that various changes in form and details may be made therein without departing from the spirit and scope of the disclosure.

What is claimed is:

1. A chip type electric device comprising:
a body;
a pair of electrodes coupled to the body, for electrically connecting the body to a pad of a printed circuit board; and
an insulating layer for covering a surface of the electrodes and the body.

2. The chip type electric device according to claim 1, wherein at least two pairs of electrodes are coupled to the body.

3. The chip type electric device according to claim 1, wherein the body and the insulating layer are formed as a unit.

4. The chip type electric device according to claim 1, wherein the body comprises a ceramic substrate formed of an insulating material, and a resistor element formed of a resistance material.

5. The chip type electric device according to claim 4, wherein the resistor element is electrically connected to the pair of electrodes.

6. The chip type electric device according to claim 1, wherein the body comprises a ferrite layer and a conductive wiring passing through the ferrite layer.

7. A liquid crystal display module comprising:
a liquid crystal display panel;
a printed circuit board connected to the liquid crystal display panel through a film;
a conductive structure for surrounding a part of the liquid crystal display panel; and
a chip type electric device packaged in the printed circuit board comprising
a body,
a pair of electrodes coupled to the body, for electrically connecting the body to a pad of a printed circuit board, and
an insulating layer for covering a surface of the electrodes and the body.

8. The liquid crystal display module according to claim 7, wherein at least two pairs of electrodes are coupled to the body.

9. The liquid crystal display module according to claim 7, wherein the body and the insulating layer are formed as a unit.

10. The liquid crystal display module according to claim 7, wherein the body comprises a ceramic substrate formed of an insulating material, and a resistor element formed of a resistance material.

11. The liquid crystal display module according to claim 10, wherein the resistor element is electrically connected to the pair of electrodes.

12. The liquid crystal display module according to claim 7, wherein the body comprises a ferrite layer and a conductive wiring passing through the ferrite layer.
